(19) United States
(12) Patent Application Publication
(10) Pub. No.: US 2024/0292813 A1
(43) Pub. Date: Sep. 5, 2024

(54) Weighted Replaceable Cat Scratching Post

(71) Applicant: Austin C. Farwell, Oviedo, FL (US)

(72) Inventor: Austin C. Farwell, Oviedo, FL (US)

(21) Appl. No.: 18/586,254

(22) Filed: Feb. 23, 2024

Related U.S. Application Data
(60) Provisional application No. 63/488,432, filed on Mar. 3, 2023.

(51) Int. Cl. A01K 15/02

(52) U.S. Cl. CPC A01K 15/024

(57) ABSTRACT

A weighted scratching post for cats. The weighted base prevents the post from tipping or falling over. The post is detachable to allow it to be replaced. The post is made of material such as sisal which is appealing to cats. There is additionally an accessory attachment point on the base, to which the user can connect other toys or accessories for the cat.

The current application claims a priority to the U.S. Provisional Patent application Ser. No. 63/488,432 filed on Mar. 3, 2023.

### FIELD OF THE INVENTION

The present invention relates generally to furniture and accessories for pets and animals. Specifically, the present invention relates to scratching posts for cats.

### BACKGROUND OF THE INVENTION

It is common for domestic cats to frequently scratch objects and furniture within a dwelling. Existing scratching posts may too light, and risk falling and injuring the cat, or may require a completely new purchase to replace a damaged scratching post. There thus exists a need to provide an object that is appealing for a cat to scratch, while still being stable to avoid falls, and having replaceable components to ensure longevity of the product.

Thus, it is an objective of the present invention to provide a stable scratching post having replaceable componentry. The present invention is a scratching post for cats having a weighted base plate with a grooved center hole. The grooved center hole is adapted to receive an end of a replaceable scratching post, such as by having a threaded end of the replaceable scratching post screw into the base plate. The replaceable scratching post is ideally made of sisal, an appealing material for cats to scratch which is also easily recyclable. There is optionally an additional attachment point for attaching other various accessories or pet toys to the weighted base plate.

### BRIEF DESCRIPTION OF THE DRAWINGS

FIG. 1 is a perspective view of the present invention.

FIG. 2 is a front view of the present invention.

FIG. 3 is a back view of the present invention.

FIG. 4 is a right view of the present invention.

FIG. 5 is a left view of the present invention.

FIG. 6 is a top view of the present invention.

FIG. 7 is a bottom view of the present invention.

### DETAIL DESCRIPTIONS OF THE INVENTION

All illustrations of the drawings are for the purpose of describing selected versions of the present invention and are not intended to limit the scope of the present invention.

The present invention is a cat scratching device comprising a base plate and a replaceable scratching post.

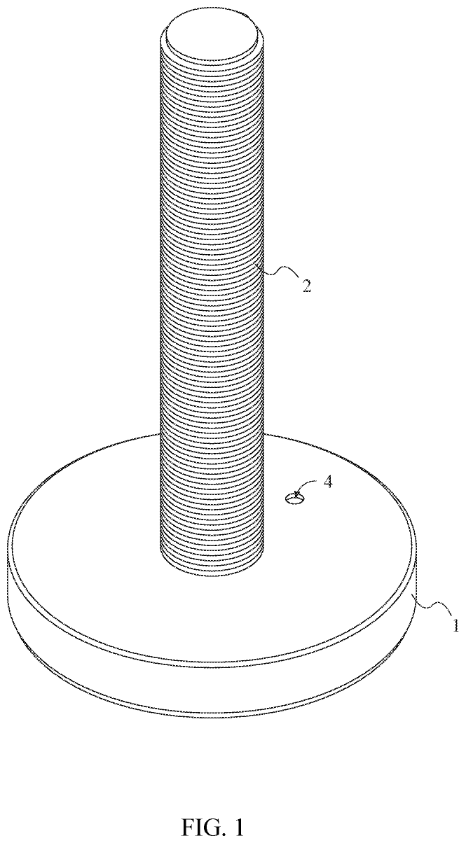

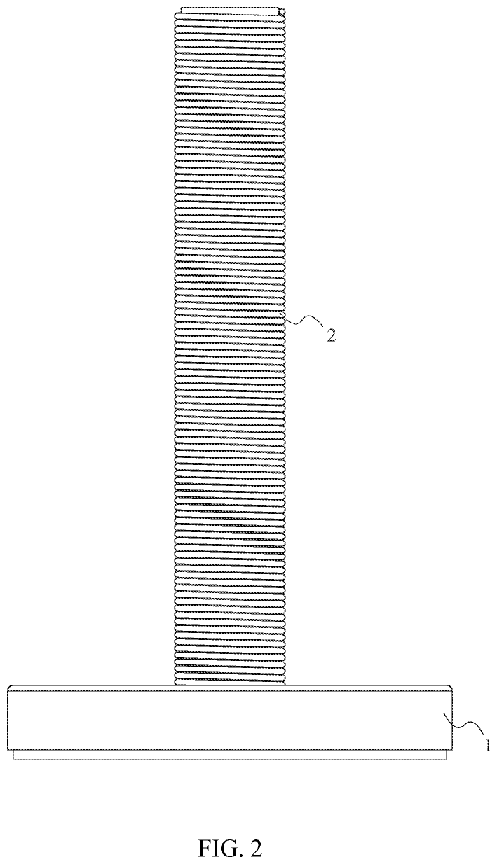

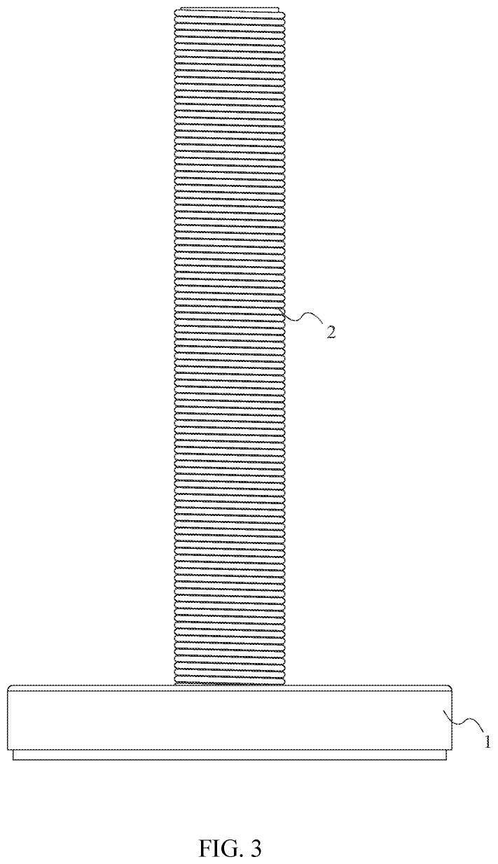

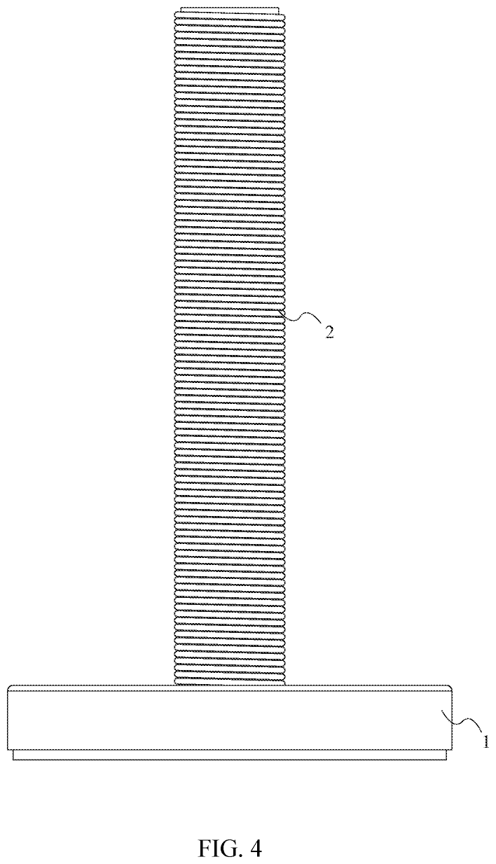

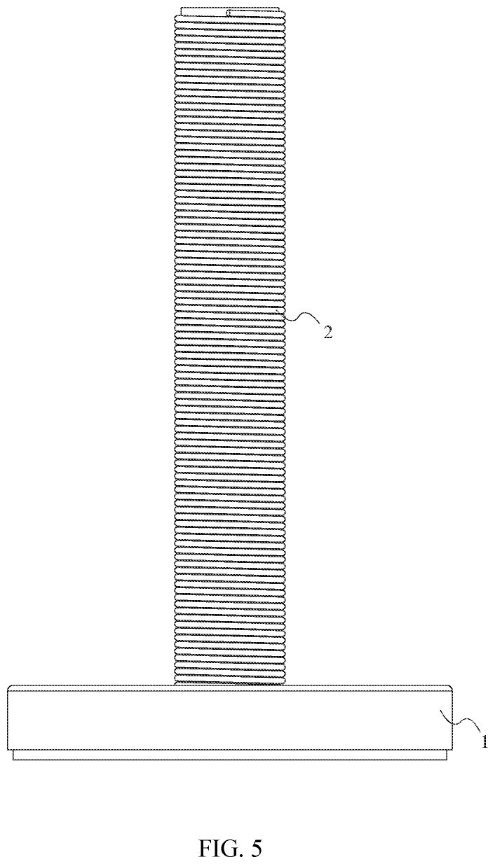

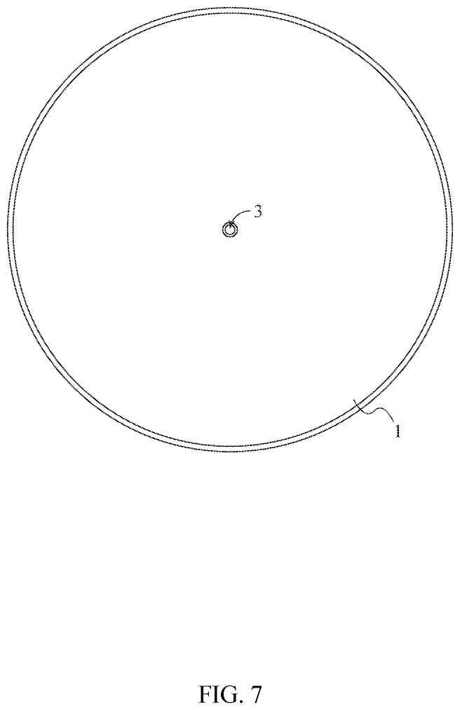

As seen in the FIGS. 1-7, the present invention comprises a base plate 1. In the ideal embodiment, the base plate 1 is weighted to prevent the cat scratching post 2 from tipping, rocking, or being knocked out of position during use by an animal. Various different weights are contemplated for the base plate 1 based on the needs of the user, varying from light to heavy—for example, in one embodiment, the base plate 1 may weigh 45 pounds, though any other weight is contemplated. As seen in the Figures, in the ideal embodiment, the base plate 1 is circular in shape. It should be noted that any other weight, shape, or size of the base plate 1 is considered within the spirit and scope of the present invention.

As seen in FIGS. 1-7, the replaceable scratching post 2 is ideally cylindrical in shape and extends upwards from the weighted base 1, though the shape of the scratching post 2 may vary. In the ideal embodiment, the scratching post 2 is made of sisal, which is a fairly ubiquitous and sustainable material, being recyclable. Sisal is an attractive material for cats to scratch and is readily available. However, any other similar material that possesses similar properties should be considered within the spirit and scope of the present invention. The bottom of the replaceable scratching post 2 further comprises an attachment point 3. The attachment point 3 is adapted to attach to a fastener located on the base plate. In the ideal embodiment, the attachment point 3 would comprise threading. The threading may be either “male” (extruding threads) or “female” (being indented to receive an extruding thread). More details on how the attachment point 3 and fastener work to secure the components of the invention together are found in the following paragraphs. It should be noted that any other conventional means of attachment and detachment, such as adhesive, hook-and-loop, screws, nuts, bolts, and other similar means of removable fastening to secure two pieces of material together are considered within the spirit and scope of the present invention.

The base plate 1 may further comprise a fastener. The fastener is adapted to secure and subsequently release the replaceable scratching post 2 to and from the base plate 1. In the ideal embodiment, the fastener comprises a round hole through the base plate 1, running from top to bottom. The outer edges of the round hole further comprise threading. The threading may be either “male” (extruding threads) or “female” (being indented to receive an extruding thread). In the ideal embodiment, the threading should be the opposite of an attachment point 3 on the replaceable scratching post 2, such that the fastener on the base plate 1 is adapted to receive the attachment point 3 on the replaceable scratching post 2 to join them together. For example, in the ideal embodiment, the base plate 1 would have female threading, while the scratching post 2 would have male threading, enabling the scratching post 2 to screw into the base plate 1 to affix the two pieces together. The base plate 1 may further comprise a locking nut to secure the scratching post in place.

When the user desires to replace the scratching post 2, the user would simply unscrew the scratching post 2 from the base plate 1, enabling a new scratching post 2 to be screwed in to replace the old scratching post 2. It should be understood that any similar means of fastening the scratching post 2 to the base plate 1 are contemplated by the current invention. Any conventional means of removable fastening, such as adhesive, hook-and-loop, screws, nuts, bolts, and other similar means of removable fastening to secure two pieces of material together are considered within the spirit and scope of the present invention.

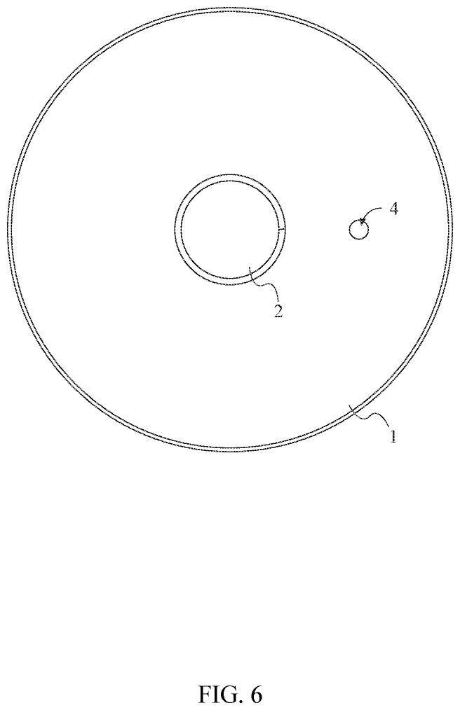

As seen in FIG. 6, the base plate 1 may further comprise an accessory attachment point 4. The accessory attachment point 4 may be adapted to receive an additional accessory, attachment, or toy for the cat scratching post. The accessory attachment point 4 may secure the accessory by any suitable means or fastener, such as adhesive, hook-and-loop, screws, nuts, bolts, and other similar means of removable fastening to secure two pieces of material together are considered within the spirit and scope of the present invention. The accessory attachment point may further comprise a locking nut.

Although the invention has been explained in relation to its preferred embodiment, it is to be understood that many other possible modifications and variations can be made without departing from the spirit and scope of the invention.

What is claimed is:

1. A scratching device for cats comprising,
a base plate, said base plate being weighted to prevent the device from tipping or being knocked over;
a scratching post, said scratching post extending upwardly from the base plate; and
a main attachment point, said main attaching point allowing the scratching post to connect to the base plate through means including but not limited to threading, adhesives, hook-and-loop, screws, nuts, or bolts, and further comprising a locking nut to secure the post in place.

2. The scratching device of claim 1, further comprising,
an accessory attachment point, said accessory attachment point being located on the base plate, comprising a hole adapted to receive additional accessories, attachments, or toys into the scratching device;
the accessory attachment point further comprising a means of securing the accessory to the base plate including but not limited to fasteners, threading, adhesives, hook-and-loop, screws, nuts, or bolts, and further comprising a locking nut to secure the accessory in place.

3. The scratching device of claim 1, allowing the user to replace the scratching post by detaching the scratching post from the base plate, then attaching a new scratching post to the base plate.
